(19) United States
(12) Patent Application Publication
(10) Pub. No.: US 2009/0229420 A1
(43) Pub. Date: Sep. 17, 2009

(54) MalletHead Pro 3

(76) Inventor: Gordon Clelland Cobb, Picton (CA)

Correspondence Address: Gordon Cobb, 3857 County Road 8, R.R. 4 Picton, ON, K0K 2T0, CA

(21) Appl. No.: 12/221,555

(22) Filed: Aug. 5, 2008

(30) Foreign Application Priority Data
Jul. 5, 2007 (CA) 2594152

(51) Int. Cl. B25D 1/02; B25D 1/10

(52) U.S. Cl. 81/21; 81/25

(57) ABSTRACT

The invention herein called MalletHead Pro 3 consists of three (3) compression molded Styrene Butadiene Rubber heads designed to be placed over and cap the face, poll and neck of any hammer having a face striking size of no greater than three and one half centimeters (3.5) and having a face striking size of no less than two and one half centimeters (2.5), consequently converting the striking tool (hammer) into a soft impact tool.

The three (3) rubber heads herein called MalletHead are of identical shape, size, and materials as shown in FIG. 1 attached hereto to this application. The three heads (3) differ in (a) colour, and (b) durometer.

This invention may be used were any soft impact tool is warranted or required.

This invention eliminates the need in many applications for the use, storage of a rubber mallet or any other soft impact tool.
This invention utilizes the hammer, including ball peen, claw or rip designs into a multi-use soft impact tool.

The invention herein called MalletHead Pro 3 is a compression molded product make of rubber compounds namely Styrene Butadiene Rubber.

MalletHead Pro 3 consists of three compression molded heads which are identical of size, shape and of the same materials.

The three MalletHeads differ in the following manner
(a) MalletHead Red (soft) having a durometer of no less than 46 and durometer of no greater than 56
(b) MalletHead White (medium) having a durometer of no less than 57 and a durometer no greater than 66
(c) MalletHead Blue (blue) having a durometer of no less than 67 and a durometer of no greater than 76

The MalletHead Pro 3 is designed to be used as a soft impact tool when placed over and cap and the face of any hammer having a face, poll and neck of the sizes mentioned herein. MalletHead Pro 3 would appeal to any applications where a variety of soft impact tools are warranted or required.

At present, prior art of this invention is unknown, as a formal search of previous registered products has proven to be negative.

MalletHead, when utilized the MalletHead by placing over the and cap the face, poll and or neck of any hammer having the face dimensions as described herein, thereby converting the striking tool into a multi-use soft impact tool.

The invention, in many applications will eliminate the need, storage and use of a standard rubber mallet.

### DESCRIPTION OF DRAWINGS

FIG. 1 provides the Front View of the Mallethead Pro 3

FIG. 2 provides the Back View of the Mallethead Pro 3

FIG. 3 provides the Side View of the MalletHead Pro 3

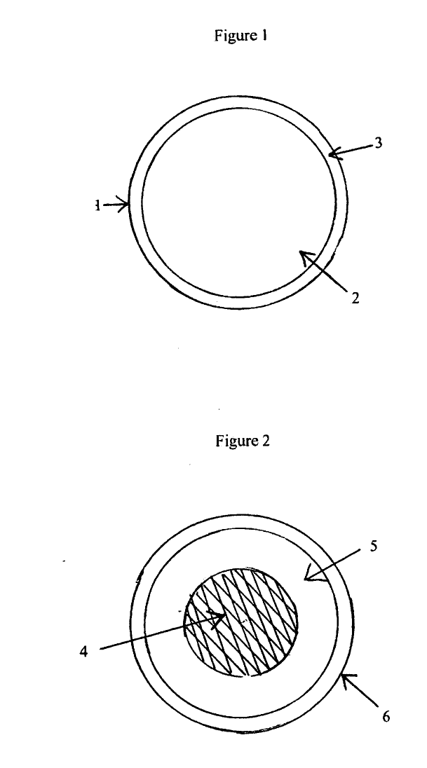

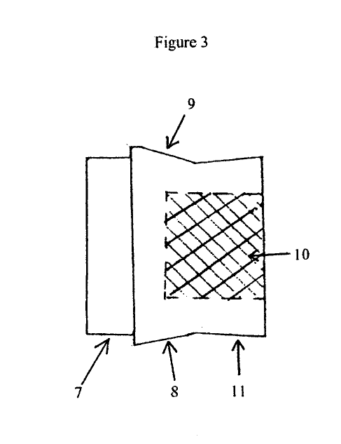

### DETAILED DESCRIPTION OF THE PREFERRED EMBODIMENTS AND SPECIFICATIONS

In FIG. 1, element #1 indicates a overall diameter of MalletHead which is 5.45 cm.; element #2 indicates the face of MalletHead and having a diameter of 4.85 cm. while element #3 indicates width of the rib being 30 cm. the difference between the size of the face and the overall diameter of MalletHead which is 60 cm. and acts as a rib in the design of Mallethead.

The imbodiements of the invention in which an exclusive property or priviledge is claimed are defined as set out below:

1. The invention herein referred to MalletHead Pro 3, as described herein this application when placed and capped over the face, poll and or neck of any hammer having the face dimensions as described herein, consequently converting that striking tool into a multi-use soft impact tool when striking any objects, materials and or things.

2. That this invention herein referred to as MalletHead Pro 3 encompass any product by design and dimension using any materials for the sole purpose of placing the claimed invention over and capping the face, poll and or neck of any hammer having the dimensions as described herein, consequently converting same into a multi-use soft impact tool when striking any objects, materials and or things.

3. The dimensions of the claimed invention herein referred to and described as MalletHead Pro 3 may change and vary from time to time as to Accommodate any and other changes t the face size, poll and or neck of new striking tools during the term of this patent or any renewals thereof, should same be approved.
